(19) United States
(12) Patent Application Publication
(10) Pub. No.: US 2008/0029217 A1
(43) Pub. Date: Feb. 7, 2008

(54) Techniques for Labeling of Plastic, Glass or Metal Containers or Surfaces with Polymeric Labels Employing an Activated Hydrophilic Adhesive

(76) Inventor: Peter J. Dronzek JR., Thornwood, NY (US)

Correspondence Address: HEDMAN & COSTIGAN P.C., 1185 AVENUE OF THE AMERICAS, NEW YORK, NY, 10036, US

(21) Appl. No.: 11/795,539

(22) PCT Filed: Jan. 19, 2006
(86) PCT No.: PCT/US06/01874

§ 371 Date: Jul. 18, 2007

Related U.S. Application Data
(60) Provisional application No. 60/646,836, filed on Jan. 24, 2005.

(51) Int. Cl. B29C 65/48

(52) U.S. Cl. 156/336

(57) ABSTRACT

The invention provides a method for fastening a pre-coated paper label to a glass, plastic or metal container or surface by means of a water based composition containing at least 30% by dry weight of animal glue or natural or synthetic polymers that can be activated into an adhesive by the following steps: (a) applying a layer of a hydrophilic solid material based on at least 30% by weight on protein from animal renderings or natural or synthetic polymers to a paper label substrate to form a hydrophilic layer that acts as an adhesive layer when activated with an aqueous medium; (b) applying a minimal amount of water or water containing a cross-linking agent to the activatable hydrophilic layer to activate said activatable hydrophilic layer into an adhesive and form a fastenable paper label; (c) fastening the fastenable paper label to a glass, plastic or metal container or surface; and (d) allowing said the paper label to dry on the glass, plastic or metal container or surface.

### FIELD OF THE INVENTION

This invention relates to pre-coated paper sheets or rolls particularly adapted for use as labels in the post mold labeling of plastic, glass or metal containers or surfaces. More particularly, the present invention relates to paper substrates adapted for printing that also have a pre-coated hydrophilic surface layer activatable into an adhesive layer for use as labels in post mold labeling applications using conventional wet applied water based labeling equipmient typically used for the application of paper labels where the adhesive layer is applied on the labeler utilizing a wet (aqueous) glue layer. In another aspect the invention relates to such labels which possess the pre-applied activatable adhesive layer which are able to be applied on conventional post mold paper labeling equipment using wet applied water based solutions comprising water or water blended with a selected cross-linking agent.

### BACKGROUND OF THE INVENTION

Plastic and glass containers or bottles are prevalent in a wide variety of shapes and sizes for holding many different types of materials such as detergents, chemicals, motor oil, beer, etc. These containers are glass or plastic (mono or multi layers) of polyethylene, polypropylene, polyester or vinyl along with other specialty blends for specific barrier and product resistance performance. Generally such containers are provided with a label which designates the trade name of the product and may contain other information as well, The early art which still is prevalent today employed the use of labels manufactured from paper substrates that were applied with a water based adhesive where the water based adhesive is applied to the paper substrate on the labeling machine.

One of the oldest and still prevalent labeling techniques is the application of paper based labels to glass and plastic containers using natural and synthetic labeling adhesives such as BL300 produced by Henkel Adhesives or OC363-20 produced by O.C. Adhesives Corp. which are known in the art. This is a safe (water based) proven technology that has grown and been employed for many years and consequently there are many existing machines that have been installed for this type of labeling technique such as from Krones, Neutraubling, Germany that run cut precut labels or Koyo, Japan which runs roll stock that is cut on machine to the label size. The wet labeling adhesives are typically high viscosity mixtures that are difficult to handle, machine and consistently meter in a uniform and consistent manner. Typical adhesive application on the labeler can vary from 1-4 wet mils of adhesive at a typical 50% solids which is a range of 8-32 pounds of adhesive for a 3000 square foot ream of paper. Additionally, many of these machines run constantly 24 hours a day and the maintenance and clean up of the adhesive applicator causes a lot of down time on the line and cost in labor and lost production.

The cut label techniques and associated adhesives work well with paper based substrates applied to glass, plastic or metal containers because the wet adhesive wicks (absorbs) into the paper substrate from the applicator roll, pad or pallet which breathes and allows the moisture from the water carrier to be absorbed by and dry thru the paper base.

Typically, wet applied cut label machines work where glued pallets rotate and come in contact with a glue applicator roll and become wetted with adhesive. The adhesive wetted pallet then is pressed in contact with the back side of the paper label where the adhesive penetrates the paper fiber with enough initial tack to remove the label out of the label holding magazine while simultaneously gluing the back side of the label. This is accomplished by applying a thin glue film to the pallet of 1 to 4 wet mils of adhesive picked up from the applicator roll metering system in a pattern or with 100% coverage which is then pressed in intimate contact against the first label in the stack. The glue roller and pallet systems in the current art typically employ a steel glue roller and a hard rubber pallet with a durometer greater than 60 or a rubber glue roller and an aluminum or coated steel pallet. Either combination provides for a firm pallet to transfer the adhesive.

After its removal, the label sticks on the entire glued area of the pallet until transferred to a “gripper” cylinder and is removed from the pallet typically using a mechanical finger or vacuum mechanism. The gripper cylinder then transfers the label to the container to be labeled. The various machine designs and techniques are well known within the labeling industry and to those skilled in the art. The “Krones Manual Of Labeling Technology” by Hermann Kronseder dated December 1978, is hereby incorporated by reference.

In recent years, as described in U.S. Pat. Nos. 6,663,746 and 6,517,664, which are incorporated by reference, polymeric film labels using a hydrophilic glue receptive layer and a water based adhesive composition are now being used. The applications also describe the concept of rewetting the hydrophilic layer with an aqueous medium (water that may contain a cross-linking agent) to activate the hydrophilic layer into an adhesive layer. It has surprisingly been found that this concept, having a pre-applied adhesive layer that is activatable into an adhesive on the labeler using water, a water based solution or water with a crosslinking agent provides a unique cost saving approach to labeling on cut and stack label machines when the pre-applied activateable coating is applied to a paper label substrate.

Accordingly, it is an object of the invention to provide a pre-coated paper label particularly adapted for use in post mold wet applied labeling of polymeric, glass and metal containers that has a dry non pressure sensitive hydrophilic layer uniformly pre-applied that can be activated into an adhesive layer. This is accomplished by pre-applying by coating, the layer that is activated on the labeling machine with an aqueous medium that is not an adhesive to become tacky and function as an adhesive to affix the label to the container. The activated label will readily feed from the label magazine or gripper, adhere with sufficient tack without moving through post labeling handling and processing including but not limited to conveying, filling, case packing and palletizing.

It is a primary object of the invention to provide a paper label with a pre-applied hydrophilic layer consisting of at least 30% dry by weight of animal glue that can be activated into an adhesive layer through an aqueous medium on the labeler particularly adapted for use in post mold labeling of polymeric and glass containers that would have sufficient wet tack and affinity for water or a water based solution to allow for transfer of the water or solution to the paper label substrate from the applicator roll(s), pad(s) or pallet(s) of the labeling machine to activate it into an adhesive. The combination of the pre-coated activatable hydrophilic layer and activating solution combine to form the adhesive to adhere the label to the surface to be labeled.

### SUMMARY OF THE INVENTION

In considering the performance or economic shortcomings of prior art materials, I have discovered an improvement to the process of labeling paper labels on an automatic labeler by which a paper label with a uniform pre-applied hydrophilic layer comprising at least 30% by dry weight of a animal glue can be applied to a container by activating the hydrophilic layer to form a tacky adhesive when wet on the labeler by an aqueous medium before being applied to a glass, plastic or metal container or surface. The process may be carried out in a more consistent and uniform manner than a labeling process that uses a non activatable layer that requires a heavy adhesive layer applied on the label machine to function. The method of the invention comprises:

(a) applying a uniform layer of a hydrophilic solid material containing at least 30% by dry weight of animal glue to a paper label substrate based on the combined weight of the hydrophilic solid material and the weight of the animal glue and any additive, e.g. cross-linker, and optionally drying said hydrophilic solid material to form an activatable hydrophilic layer on said paper label that can be activated into a tacky adhesive;

(b) applying on a labeler a light deposition of water or water containing a cross-linking agent over said activatable hydrophilic layer to form a tacky fastenable paper label free of bubbles and uneven adhesive streaks typical of the standard deposition of adhesives applied on aqueous labelers;

(c) fastening said fastenable paper label to a glass, plastic or metal container or surface; and

(d) curing said paper label on said glass, plastic or metal surface or container.

Containers labeled according to the process of the invention, where a cross-linker is present in the dried adhesive composition which is made up of the activatable hydrophilic layer and activating solution are novel articles as they have a label that has not been previously described.

It has been found that cellulose based substrates with a porous structure like paper that are judiciously applied with an activateable hydrophilic layer show superior adhesion when rewet and pressed onto the glass metal or plastic container because the open area of the paper fibers provides enhanced surface area for penetration and enhanced adhesion.

### DETAILED DESCRIPTION OF THE INVENTION

Pre-applied activatable hydrophilic materials containing animal glue that can function as an adhesive are formulated so that the activatable adhesive coating will have hydrophilicity, absorbtivity, wet tack and drying properties that will permit the paper label to be applied to polymeric, glass or metal containers via water based wet labeling techniques on standard paper labeling equipment using a water based solution or a water based solution plus a crosslinker but not an adhesive as conventionally used on paper labelers in the current art. It is contemplated that the pre-applied hydrophilic material will be dried on the paper substrate and rewetted at the time that the labeling material is applied to a container. The apparatus which is used to apply paper labels is well known to those in the art. The paper label substrate with the activatable hydrophilic layer will demonstrate sufficient “wet tack” during the label application period and the label drying period to permit containers to be handled and processed.

As used herein the reference to a “container” includes a surface of an object made of glass, plastic or metals such as bottles, cans, toys and building materials.

The activatable hydrophilic component or blends containing animal glue will be applied in the present invention to the selected paper sheet in a continuous or patterned layer to provide the absorptive, wet tack, adhesive and drying properties that are necessary to enable paper sheets to be successfully used as label substrates on polymeric or glass containers when activated through wetting with water or water and a cross-linker where the labeling apparatus is configured to apply the minimum amount of aqueous solution to activate the layer into a tacky adhesive when wet, but not excess aqueous medium to saturate the activatable layer causing it to loose its adhesive properties and not adhere well and take a long time to dry. The activatable hydrophilic layer which is applied through the sizing or coating process on a paper making machine, by coating on a coating machine off-line from the paper manufacturing step or in-line with printing on a printing press has the function of absorbing moisture to activate the layer as an adhesive when wet with an aqueous medium thus causing selected hydrophilic layers to function as an adhesive without any applied adhesive as is conventionally performed on aqueous labeling machines in the art. It is important and key to this invention to minimize the amount of aqueous medium used to activate the hydrophilic layer as an adhesive. Excess activation moisture decreases the tack of the activated layer as it becomes saturated with moisture and will lead to longer drying times and loss of adhesion properties. Additionally, the ability to minimize machine applied imperfections such as bubbles and streaks typical in the current art when heavy adhesive layers are applied on the labeling machine is dictated by the amount of activating medium used and if excess is used, it detracts from the concept of a pre-applied defect free adhesively activated hydrophilic layer.

As previously mentioned, typical adhesive application on a paper labeling machine using adhesive is from 4-16 lbs./ream dry application. Using the pre-applied technique of this invention, the activatable layer can be coated at 2-8 lbs./ream, preferably 2-4 lbs./ream and activated with minimal moisture to effectively eliminate in most applications up to >50% or more of the adhesive layer resulting in an approximately >50% or more savings in adhesive cost as a tangible savings. Applying a light deposition of water or water based solution will allow for increased label line up time and efficiency and less maintenance and clean-up cost of the glue applicator and associated equipment from the high viscosity glues commonly used all leading to intangible savings that will be difficult to put a hard cost on but will be significant.

The term “paper facestock” or “paper label substrate” as used herein should be taken for purposes of the present invention to refer to a paper material that can be uncoated, coated or sized on one or two sides so that it is rendered printable by conventional printing techniques such as gravure, flexographic, lithographic, screen or other digital techniques such as ink jet, laser and thermal transfer.

The “activatable hydrophilic layer” previously mentioned has the properties after application to the paper but before activation of minimal tack when dry so labels can be unwound from a roll or separated from a stack and once activated with moisture, it will have the properties of wet tack, absorbtivity, drying, sufficient adhesion to the paper label substrate and affinity and adhesion to the container to be labeled in the wet or dry form.

An activatable hydrophilic layer is defined as containing at least 30% by dry weight of animal glue that can be wet or remoistened with a water based solution for use on a glass, plastic or metal container.

As used herein and in the appended claims, the term “hydrophilic” is used to describe materials or mixtures of materials which bind, pass or absorb water. The term “activatable hydrophilic layer” describes a hydrophilic layer that when binding, passing or absorbing water becomes activated and transforms into an adhesive layer with wet tack and affinity for the container to be labeled. The term activated as used herein describes the change in a dry pre-applied dry hydrophilic layer on a label substrate to a wet adhesive layer when activated with an aqueous medium that will adhere to the container wall to be labeled, dry and set up with strong adhesion.

The preferred “activatable hydrophilic” materials of the present invention are based on animal glue coating which in broad terms is an organic colloid of protein derivation from collagen which is a protein constituent of hide materials and bones obtained using well know techniques widely used to provide many commercially available glues. Hide animal glue is preferred over bone animal glue because of superior physical properties and strength. The animal source is not critical and glues may be derived from wild or domesticated animals such as horses, cattle, pigs, sheep and the like. Purified versions of animal glue are also known as gelatin. Animal glues are commonly graded on comparative gel gram strength values by manufacturers and provides a rough guide for use but this standard does not always measure their working qualities as adhesives for glass, plastic and metal containers. Considerations of gram strength, pH, ash content, clarity, grease content, type of glue (bone of hide), degree of purification and processing methods all have a bearing. The gram strength measurement of animal glue is also known as a gel strength measurement which ranges from about 30 grams (weak) to 500 grams (exceptionally strong) where the highest gram strengths contain greater amounts of reactive glue protein. Typically, stronger adhesive bonds are achieved with higher gram strength animal glues and blends of animal glues. Unfortunately, as gram strength increases, so does the dry brittleness of the glue which must be addressed in formulating using modifying components such as plasticizers, humectants and modifying synthetic resin dispersions.

In physical form, dry animal glues are odorless, relatively tack free hard materials ranging in clarity from light amber to dark brown depending on the origin, processing technique and degree of purification that contain 10-14% moisture. Almost all grades can be made up into aqueous solutions.

In water, solutions of animal glues based on hide which are typically the higher gram strength variety preferred for use in this invention instead of bone based glues are generally reaction neutral and have a pH range of 6.4-7.4 which is a pH that makes them compatible with many other materials. The specific gravity of dry animal glue is approximately 1.27.

An important feature of animal glue in the present invention is that when dry animal glue is placed in cold water like an ice chest for beverages, animal glues do not dissolve readily but swell absorbing considerable water forming a gel state and must be heated to dissolve into solution at 100-140° F. The rapid development of a gel state when wet with an aqueous medium provides a fast set and tackiness with quick development of initial bond and holding strength which is critical for the successful application of paper labels to glass, plastic and metal containers using wet labeling techniques. For applications where long term contact with water and subsequent swelling of the animal glue could cause a loss of adhesion, it is preferred to crosslink the animal glue to make it moisture resistant. One of the keys to this invention is maintaining the beneficial properties of non cross-linked animal glue for label application using at least 30% animal glue in the activatable hydrophilic layer which is then cross-linked and rendered moisture resistant after application by the water containing a cross-linker which is applied when the hydrophilic layer is activated into an adhesive. High speed labelers run from 200-1,200 container per minute and the cross-linking reaction is relatively slow even at high levels of cross-linker so the layer can be wet, develop tack and adhesion to the container to be labeled and cure to moisture resistant over time. This time period varies depending on the activatable layer formulation, cross-linker of choice and amount of each component used along with the amount of water that must be absorbed and dried. The time period can run from 12 hours to 14 days but stable formulations that are rendered moisture resistant in 72 hours are adequate for most commercial labeling applications. A key advantage of cross-linked activated adhesives consisting predominantly of animal glue is that when dry and rendered moisture resistant, the adhesive is not impervious and hard and in fact the adhesive layer will “give” or move slightly under high moisture conditions and contact the surface to be labeled on drying providing a “live” adhesive bond that takes up the stresses and strains that normally occur under labeling and drying conditions.

Another key benefit of an adhesive layer containing animal glue that forms a gel structure is that if the surface to be labeled is cool, the animal glue component will gel faster and set a bond faster because it is less fluid. This can be an important factor in brewery applications where post mold labeling of cold beer or cold storage of labeled containers can accelerate the bond of the activatable layer.

Another important feature of animal glue layers, particularly those deposited from water or wet with water is that when dry, they exhibit high adhesive strength, are continuous, non-crystallizing, non-cracking and of great strength and elasticity. Additionally, animal glue is reaction neutral, relatively odorless, non toxic and non corrosive. Due to its unique protein structure, animal glue is not precipitated by acids or alkali's and is resistant to structural breakdown by acids or alkali's within normal practical limits so for use as a labeling adhesive where the contents of a container could leak or drip down the side of the container and attack the adhesive, animal glue is durable. Animal glue based adhesives are also resistant to grease, oil, alcohol and other chemicals that are free of water and as stated above, to overcome moisture sensitivity, animal glue can be rendered moisture resistant by cross-linking.

For glass containers, it is preferred to use high gram strength animal glues at a level of at least 50% dry by weight of the activatable hydrophilic layer to achieve a strong bond where the gram strength of the animal glue is greater than 50 grams and more preferably in the range of 175-225 grams. More preferably, for glass containers a dry level of animal glue between 60-80% is preferred as is a ram strength in excess of 175-250 grams (also known as gel strength). The higher the gel strength of the animal glue, the stronger the adhesive bond to glass will typically be but also the more brittle the bond will become, especially after crosslinking so the 175-250 gram range while not limiting, is preferred for many applications. Animal glue shows a specific affinity for glass and coated glass and is ideal as a base component to be formulated into an activatable hydrophilic adhesive layer because of its strong wet tack and affinity for glass. Animal glue has such a strong affinity for glass that some formulations when dry and adhered to the glass will pull glass particles with it when removed. This has been proven by those that use animal glue to create chipped glass or frosted glass decorative designs using animal glue allowed to dry on glass that is subsequently removed. This high affinity and bond strength to glass is why animal glue is the key component of this invention for activatable layers on paper labels for high speed post mold labeling.

For plastic containers, it is recommended to use or blend synthetic acrylic polymers which bind or absorb water and become adhesives such as polyacrylic acid, polyacrylic acid copolymer or carboxylated sodium polyacrylate with the animal glue to promote adhesion to the plastic container wall. For plastic containers, the dry animal glue level in the activatable layer can range from 30-80% but it is preferred at a level of 35-45% in combination with synthetic polymers. Moisture sensitive synthetic polymers that can be rendered insoluble through cross-linking can be added at levels up to 70% dry polymer

Amounts of non moisture sensitive synthetic polymers can also be added as modifiers at levels up to 50% dry polymer but most preferably at levels up to 25% dry polymer.

If synthetic polymers are used, they can be in the form of solutions, dispersions and emulsions but solution polymers are preferred.

In addition to synthetic resins as discussed above, animal glue solutions are compatible with select natural resins or polymers, modifying additives such as plasticizers, oils, fats, waxes along with other adhesive materials such as casein, starch, dextrine and gums under certain conditions. Natural polymers include starch, and cellulose as well as cellulose derivatives such hydroxyethyl cellulose and the like.

To plasticize and increase the flexibility of animal glue and control lay flat, modifiers such as urea, polyethylene glycol, glycerin, sorbitol, cane or invert sugars or combinations of the preceding are added at levels up to 40% dry and most preferably 25-30% dry depending on the properties desired but preferably at levels <30% if the activatable layer is subsequently to be reacted (cross-linked) to be rendered resistant to moisture to minimize the level of non-reactive components in the matrix of the activatable hydrophilic layer. It is noted that urea acts as a gel dispersant to reduce the viscosity of the gel for coating applications while it is inert in the animal glue matrix.

A discussed above, a preferred aspect of the present invention is to use cross-linkable (reactive) components in the activating aqueous solution to react with the hydrophilic layer that converts into an adhesive that cures to become more moisture resistant as it dries and builds adhesion to the container wall. Not only does the cross-linking agent make the activated adhesive more moisture resistant, it can provide greater initial wet tack versus using water only and promotes adhesion to the container wall while increasing chemical resistance to materials that may come in contact with the adhesive layer. Examples of synthetic cross-linkable materials are those which contain carboxyl groups, hydroxyl groups or other functional group which will react with a cross-linking agent. When water and a cross-linking agent are combined, the composition will comprise 0.005-10% by wt. of cross-linking agent. Preferred crosslinking agents are Polycup 172 from Hercules and Glyoxal available from BASF Corporation.

The activatable hydrophilic layer converts to a wet tacky adhesive layer when wet with an aqueous solution which is defined as a substance capable of combining two surfaces by the formation of a bond.

The use of the properly formulated activatable hydrophilic layer for a given paper labeling substrate and container to be labeled will have a direct effect on the speed which the labeling line can be run. When considering the choice of the activatable material which forms the hydrophilic layer, one must consider the paper label substrate, container to be labeled, labeling machinery, activation technique and down stream processing requirements such as filling, conveying and packing. Generally, a dry deposit of from 2 to 8 lbs./3000 square feet of the activatable hydrophilic layer, when dried, may be employed on the paper layer depending on the particular material that is selected. Preferably, 2-4 lbs./3000 square feet is preferred.

It is critical to the successful application and use of an activatable hydrophilic paper label to control how the water or water based adhesive is applied to the activatable hydrophilic layer, how deposition (weight or thickness) is controlled and how the resultant combination with the container is pressed together. Generally, from <0.05 to 1.0 g./sq. ft. of activating medium (water or water plus crosslinker) is applied to the pre-applied activatable hydrophilic layer with 100% coverage of the label with a preferred range of 0.1-0.25 g./sq. ft. If a grid or other pattern of activating medium is employed, then the amount of activating medium may be reduced. If a grid pattern is employed, the hydrophilic layer may be applied to be substantially in register with the activating medium.

It is critical to the successful application and use of an activatable hydrophilic paper label to precisely control how the amount of aqueous activating fluid medium (water or water plus a cross-linker) is applied so that an effective amount will be employed. Too much aqueous medium for a given deposition of activatable hydrophilic layer will overpower the layer and will result in loss of tack and initial adhesion and will result in labels ‘swimming: or moving as the labeled container is conveyed, filled or packed and will increase the drying time of the activated layer to produce a firm adhesive bond to the wall of the labeled container. Not enough aqueous activating medium will not completely develop the full adhesive properties of the activatable layer and will result in poor bonds.

For optimum aqueous medium application control, optical appearance and uniformity, it has been found that it is preferable to use smooth applicator pallets to apply the activating solution which for purposes of this invention includes water or water plus a crosslinking agent. The activating solution is not limited to these components but will include them as a major portion of the activating solution with minor components such as biocides, wetting agents, fragrances, humectants, defoaming agents, viscosity modifiers and Theological modifiers also contemplated.

In a preferred embodiment, conventional hard rubber, metal or aluminum glue applicator pallets are modified by adhering a compressible surface like a foam layer with a smooth surface to the adhesive or activating side of the pallet. This allows for intimate contact between the applicator pallet and applicator metering roll when the activating solution is applied to the compressible surface and for intimate contact between the wetted pallet and the hydrophilic layer when the wetted pallet with activating solution is pressed in intimate contact with the hydrophilic layer. Compression of the soft foam like layer as it contacts the wetted applicator roll in contact with the activating solution is important as a means of uniformly controlling pick up of the activator solution. As detailed earlier, it is critical to control the deposition of the activating medium to a low level. The compression of the foam modified pallet in combination with the gap adjustment of the applicator roll system allows for uniform metering and control of the activating solution. An added benefit is that the compression causes a wiping action as the compressible surface of the applicator pallet rotates past the applicator roll to pick up the activating solution providing for a uniform application of solution where uneven application or even foam is smoothed out and made uniform.

When the wetted compressible pallet comes in contact with the activatable hydrophilic layer to pull the label out of the basket for application, the intimate contact of the compression provides for uniform application and wetting of the activatable hydrophilic layer to promote best optical clarity and ultimate adhesion of the label after drying.

The modified compressible surface must be smooth and wettable which means the activating solution must wet out on the surface. In a preferred embodiment, the foam will compress at least 5% of its thickness for the optimum wiping action and will have a durometer of <50. More preferred are is compression of about 5-50% of the thickness of the label and preferably >10% and a durometer of about 10-40 and preferably <30 with a glass smooth surface. The type of compressible foam like substance is not limiting but durable compounds like silicone and urethane polymers are preferred.

As with any adhesive labeling technique, the type of bond achieved is a fine balance between the container surface to be labeled, the label material, adhesive formulation which in this case is the activatable hydrophilic layer in combination with the aqueous activating fluid and the deposition of the activated adhesive. For purposes of this invention, the adhesive layer is the combination of the activatable hydrophilic formulation and the activating medium whether it is water or water and a cross-linking agent. The ultimate adhesion properties are controlled by the surface characteristics of the material to be labeled and the choice of adhesive layer formulation and deposition of the adhesive layer

The choice of the adhesive layer made up of the activatable hydrophilic layer and activating medium, the type of label substrate and container to be adhered together, the plant processing conditions after labeling, storage requirements and the end use requirements that must be met such as high temperature resistance, ice proofness or passing a 24-72 hour ice bath soak are important considerations. There are many more specific variables within these considerations all of which influence the formulation of the proper activatable hydrophilic layer and activating medium for a specific application.

The bonding of the activatable layer can be accomplished with mechanical (non smooth surfaces) and specific adhesion. It has been found that the preferred animal glue component of the activatable layer provides superior adhesion characteristics when the layer is activated by water or a water containing a crosslinking agent such as zirconium salts of mineral acids, such as Bacote 20 from Magnesium Elektron, Inc., water soluble polyamide-epichlorohydrin material such as Polycup 172 from Hercules, Glyoxal available from BASF Corporation or an aldehyde donor such as Glutaraldehyde that rapidly cross-links the animal glue and the like which may be used at a level of 0.01-8% by weight of the activatable layer composition.

Mechanical adhesion is defined as the bonding between surfaces in which the adhesive holds the parts together by inter-locking action and actual physical penetration. Specific adhesion is the bonding between surfaces which are held together by molecular forces wherein the surfaces are non porous and no penetration is possible. These forces are related to the polarity and size of the molecules, pore size of non smooth surfaces and the initial action in obtaining a bond when the activated surface is wet, becomes tacky and a bond develops through molecular forces.

The activatable hydrophilic layer and activating fluid that combine into the adhesive must wet out the surface of the container to be labeled. This is accomplished by applying the activating medium to the selected activatable hydrophilic layer which when applied to the container to be labeled brings the hydrophilic layer activated into an adhesive and container wall into intimate molecular contact. By using an aqueous fluid activating medium that wets and penetrates the hydrophilic layer as well as the container surface, a fluid region is created that flows to cover the surface as completely as possible. This is critical to the invention where even an apparently smooth surface in reality is composed of a random network of hills and valleys. When the activated hydrophilic layer is in the wet condition, it serves as a wetting bridge to promote adhesion. The more rapidly the activated hydrophilic layer can be applied (pressed in intimate contact with the surface to be labeled), the greater the fluid region will be before the activating medium is absorbed into the hydrophilic layer, the better the wetting at the adhesive interface will be resulting in stronger ultimate bonds.

Optionally, if just water or water and a cross-linking agent are used as the activating medium, it is preferred to thicken the water or solution for better machining on the labeler that is designed to handle higher viscosity mediums such as conventional labeling adhesives. Many commercially available thickeners can be used but special mention is made of the Laponite family of synthetic thickeners from Southern Clay Products that form a gel structure of an aqueous solution at low addition levels that will not overpower the adhesive properties of the activated medium and will not interfere with the ultimate bond or moisture sensitivity of the dry adhesive at the low levels used to thicken the aqueous solution.

It is clear that one specific activatable hydrophilic layer may not fit all applications but it has been found that the activatable hydrophilic layers of the present invention can be tailored to particular applications based on the conditions and requirements for wet PML labeling of paper substrates but the activatable layer must contain at least 30% by weight of the dry activatable layer of animal glue that when activated (wet) by an activating fluid medium becomes sufficiently tacky to adhere a paper label to a container through filling, conveying, processing or packing that will subsequently dry and provide good adhesion to the container. When working with natural and synthetic activatable layers that are obviously sensitive to moisture, it is important depending on the moisture sensitivity of the formulation to add a humectant to the activatable layer at a level of 0.25-25% by dry weight to provide curl resistance and to impart lay flat properties to the paper labels. The humectants also tend to act as plasticizing agents so the activatable layer does not become too brittle when dry and include urea, polyethylene glycols such as PEG400, polyvinyl alcohol, glycerin, sorbitol and the like.

Slip aids and anti-blocking compounds commonly used in the art can prevent excessive friction between the activatable hydrophilic layer and the printed label face and also control the effect of ambient moisture levels which may tend to cause label blocking and interfere with the operation of high speed automated machinery which is used to apply labels. These materials may be used at a level of 0.2-5% by weight of the activatable layer composition and/or the protective over coat applied over the printed indicia on the side of the label opposite the activatable layer and include materials such as microcrystalline wax emulsions, erucamide dispersions, polytetrafluoroethylene compositions, silicone beads, modified silicone solutions, parafin wax emulsions, high melting polypropylene emulsions, carnauba wax emulsions, oxidized ethylene/EVA compositions, micronized polyethylene wax/PTFE emulsions, micronized polypropylene, micronized fluorocarbons such as PTFE (Teflon), micronized polyethylene, silica and talc.

Protective coatings may be used to protect the paper and printed indicia of the label when applied at a level of 0.25-4 lbs./3000 sq. ft. using conventional application techniques. These materials include styrenated acrylics such as OC1043 from O.C. Adhesives Inc., urethanes such as AS455 from Adhesion Systems Inc., Flexcon Release Varnish from Flint Ink. In a preferred embodiment, a protective coating with release (non stick) characteristics commonly known in the art is preferred as the protective overcoat to prevent blocking if the stacks of labels are exposed to moisture.

If an antistatic agent is employed in the printable over coat applied over the indicia, it may be present at a level of 0.5-3% by weight of the dry coating. These materials include quaternary ammonium salts such as Ethaquad C12, sulfonated styrene maleic anhydride, sulfonated polystyrene, sulfonated vinyl toluene maleic anhydride, conductive polymers and organo modified silicones such as Silwet L77. It is noted that anti-static agents are typically not needed in the activatable layer because the high moisture content of the animal glue provides exceptional static elimination properties.

Optionally, if a metalized coating of a thin metal film is deposited on the printable surface of the paper sheets or rolls, premium quality decorative labels with all of the advantages set forth above will be provided.

It is clear that one specific activatable hydrophilic layer may not fit all applications but hydrophilic layers can be tailored to particular applications based on the conditions and requirements for wet PML labeling of activateable paper label substrates.

Activating Solution

Cross-linker 0-10 wt %, preferably 1-10 wt %; especially preferably, 2-4 wt %

Wetting Agent 0-1 wt %, preferably <0.5 wt %

Defoamer 0-1 wt % preferably <0.wt5%

Thickener 0-2 wt %, preferably <1 wt %

Natural Polymers 0-15 wt %, preferably 5-10 wt %

Synthetic Polymers 0-10 wt %, preferably <5 wt %

Water balance to 100%

Defined terms and tests are as follows:

Wet Tack,—this is a measure of the initial adhesion of the label to a surface immediately after activation and application to the surface and evaluated by trying to push or slide the label on the surface it was applied to.

Ice Soak—Submersion of the labeled sample in an ice water/cold water bath for 72 hours. After 72 hours, the labeled article is rotated in the bath cycles and labels are evaluated for edge flagging or removal.

Edge Difficulty—this is a measure of the degree of difficulty to lift the edge of the sample after it has been allowed to dry and cure for a specified time period. W denotes wet test after ice soak, D denotes dry test.

Adhesion Rating—this is a measure of the degree of bond of the label to the surface when it is peeled back in a slow continuous motion by hand and is performed right after the edge difficulty test. If an ice soak test is performed, this test is performed on sample pre and post ice soak test.

Adhesive Action—defines whether the activatable layer splits, stays with the label or transfers to the labeled surface after the label is peeled back for the adhesion rating test. If an ice soak test is performed, this test is performed on sample pre and post ice soak test.

Curl—curl is defined as the degree the edges of the label specimen lift when exposed to changing environmental conditions in terms of temperature and humidity.

Blocking—is defined as the degree of tack versus separation of individual labels when the coated side of the label is in contact with the opposite side in a constant humidity chamber (92% RH) for 24 hours at room temperature. Since different papers are used, for comparative test purposes the non adhesive side was always evaluated against the same Flexcon varnish from Flint Ink.

All tests except Adhesive Action are rated on a scale of 0 to 3 where 0 is failure, 1 is poor, 2 is good and 3 is excellent. Adhesive Action is denoted as A for paper split or fiber tear, B stays on label, C transfers to substrate to be labeled.

Animal glues are generically denoted in gram strength.

Approximate Coat Weight—is the theoretical coat weight based on the solids of the coating and draw down road size in grams/ MSI MSI=1000 sq.in.

Type Of Paper Used—C1S denotes one side coated paper
C2S denotes two side coated paper

Activator Formulation details the formulation of the activating solution.

Surface Labeled—G denotes glass.

The technique to prepare samples is as follows:

1—Prepare Activateable Hydrophilic formulation

2—Draw down Activateable formulation on selected paper substrate

3—Dry in lab forced hot air oven

4—Prepare Activator Solution

5—Apply Activator Solution with foam pad or brush to activate with the minimum amount of solution to activate the coating

6—Rapidly apply the activated label to the surface to be labeled

7—Allow the applied label to dry/cure for 7 days.

All formulations are denoted by dry weight parts.

### EXAMPLE 1

Activatable Hydrophilic

Formulation—30 parts 192 gram strength Animal Glue
5 parts Urea
5 parts Glycerine
60 parts water

Paper Type—Metalized C1S

Approx. Coat Weight—3.2 grams/MSI

Activator Formulation—1 parts Polycup 172
1 parts Glyoxal
98 parts water

Substrate To Be Labeled—G

### EXAMPLE 2

Activatable Hydrophilic

Formulation—30 parts 192 gram strength Animal Glue
5 parts Urea
5 parts Glycerine

Paper Type—C2S 60 parts wate

Approx. Coat Weight—3.2 grams/MSI

Activator Formulation—1 parts Polycup 172
1 parts Glyoxal
98 parts water

Substrate To Be Labeled—G

I claim:

1. A process for applying a paper label to a glass, plastic or metal container or surface said process comprising:
(a) applying a layer of a hydrophilic solid material comprising at least 30% by dry weight of an animal glue based on the total weight of the hydrophilic solid material to a paper label and thereafter drying said layer of hydrophilic material to form a water activatable hydrophilic layer that can be activated into a tacky fastenable adhesive;
(b) applying a liquid comprising a sufficient amount of water or water containing a cross-linking agent, to said activatable hydrophilic layer to form a tacky fastenable paper label;
(c) fastening said tacky fastenable paper label to a glass, plastic or metal container or surface; and
(d) curing said paper label on said glass, plastic or metal surface or container.

2. A process for applying a paper label to a glass, plastic or metal container or surface as defined in claim 1 wherein the hydrophilic solid material is 90 percent by weight animal glue.

3. A process for applying a paper label to a glass, plastic or metal container or surface as defined in claim 1 wherein step (b) is carried out with the application of a sufficient amount of water to said activatable layer to form a tacky fastenable paper label.

4. A process for applying a paper label to a glass, plastic or metal container or surface as defined in claim 1 wherein step (b) is carried out with the application of a sufficient amount of water containing an effective amount of a crosslinking agent to said activatable layer to form a tacky fastenable paper label.

5. A process for applying a paper label to a glass, plastic or metal container or surface as defined in claim 1 wherein step (b) is carried out with the application of a sufficient amount of water based adhesive to said activatable layer to form a tacky fastenable paper label.

6. A process for applying a paper label to a glass, plastic or metal container or surface as defined in claim 1 wherein step (b) is carried out with the application of a sufficient amount of water based adhesive containing a effective amount of a cross-linking agent to said activatable layer to form a tacky fastenable paper label.

7. A process for applying a paper label to a glass, plastic or metal container or surface as defined in claim 1 wherein the total amount of dried hydrophilic material is from 0.02 g to 0.7 g of dried hydrophilic material per sq. cm. of paper label material.

8. A process for applying a paper label to a glass, plastic or metal container or surface as defined in claim 1 where a slip agent is added to said hydrophilic material.

9. A process for applying a paper label to a glass, plastic or metal container or surface as defined in claim 1 where an anti-block agent is added to said hydrophilic material.

10. A process for making a paper label stock for application to a glass, plastic or metal container or surface said process comprising applying a layer of a hydrophilic solid material comprising at least 30% by dry weight of an animal glue based on the total weight of the hydrophilic solid material by applying an aqueous dispersion comprising said hydrophilic solid material to a paper label stock and thereafter drying said layer of hydrophilic material.

11. A process for making a paper label stock for application to a glass, plastic or metal container or surface as defined in claim 10 wherein said aqueous dispersion of animal glue contains a cross-linking agent.

12. A process for making a paper label stock for application to a glass, plastic or metal container or surface as defined in claim 10 wherein said aqueous dispersion of animal glue contains a cross-linking agent and an slip agent.
